(19) United States
(12) Patent Application Publication
(10) Pub. No.: US 2023/0186157 A1
(43) Pub. Date: Jun. 15, 2023

(54) ESTIMATION OF A TANK SLOSHING RESPONSE USING A STATISTICAL MODEL TRAINED BY MACHINE LEARNING

(71) Applicant: GAZTRANSPORT ET TECHNIGAZ, SAINT REMY LES CHEVREUSE (FR)

(72) Inventors: Florent OUVRARD, SAINT REMY LES CHEVREUSE (FR); Alaric SIBRA, SAINT REMY LES CHEVREUSE (FR)

(21) Appl. No.: 17/924,587

(22) PCT Filed: May 11, 2021
(86) PCT No.: PCT/EP2021/062532

§ 371 Date: Nov. 10, 2022

(30) Foreign Application Priority Data
May 20, 2020 (FR) 2005227

(51) Int. Cl. G06N 20/00; F17C 3/02; B63B 79/20; B63B 79/15

(52) U.S. Cl. CPC G06N 20/00; F17C 3/025; B63B 79/20; B63B 79/15; F17C 2250/0694; F17C 2270/0105; F17C 2201/052; F17C 2260/016; F17C 2250/0417; F17C 2221/033; B63B 25/16

(57) ABSTRACT

A system and method for the estimation of a sloshing response of a sealed and thermally insulating tank for transporting liquefied gas. A statistical model is trained using a supervised machine learning method on a set of test data that may include sea test data, the statistical model being capable of estimating a sloshing response of the tank depending on a tank fill level and a current sea state, and optionally at least one of a draught, speed or course of the vessel. The statistical model trained in this manner is used to estimate a sloshing response of a sealed and thermally insulating tank for transporting liquefied gas. In an alternative embodiment, the statistical model estimates the sloshing response from a tank fill level and a current sea state, and optionally from at least one of a draught, speed or course of the vessel.

### TECHNICAL FIELD

The invention relates to the estimation of a sloshing response of a sealed and thermally insulating tank for the transport of liquefied gas. The invention relates more particularly to methods for obtaining a statistical model able to estimate a sloshing response of a tank of this kind, to methods of obtaining a database usable to estimate a sloshing response of a tank of this kind, and to management systems for a ship including at least one such tank. In the present document the term “ship” designates a means of transporting and/or using for its own propulsion liquefied gas between two points of the globe or a floating processing and/or storage unit of one or more liquefied gases. As is standard practice for ships using liquefied gas as fuel, there may be cited LNG-propelled ships, container ships, cruise ships and bulk carriers.

### TECHNOLOGICAL BACKGROUND

Sealed and thermally insulating tanks are routinely used for the storage and/or the transport of liquefied gas at low temperature, such as tanks for the transport of liquefied petroleum gas (also known as LPG) at for example a temperature between −50° C. and 0° C. inclusive or for the transport of liquefied natural gas (LNG) at approximately −162° C. at atmospheric pressure. These tanks may be intended to transport liquefied gas and/or to receive liquefied gas serving as fuel for the propulsion of the floating structure. Numerous liquefied gases may also be envisaged, in particular methane, ethane, propane, butane, ammonia gas, dihydrogen or ethylene.

Ship tanks may be single or double sealed membrane tanks that allow transport at atmospheric pressure. The sealing membranes are generally made of thin stainless steel or Invar sheet. One membrane is generally in direct contact with the liquefied gas.

During its transport the liquid contained in a tank is subjected to various movements. In particular the movements of a ship at sea, for example because of the effect of climate conditions such as the sea state or the wind, leading to agitation of liquid in the tank. The agitation of the liquid, generally referred to as sloshing, generates stresses on the walls of the tank that may compromise the integrity of the tank.

These sloshing phenomena occur on natural gas, hereinafter LNG, transport and/or user ships (often designated as “LNG as fuel” ships) or methane tankers, as well as anchored storage ships known as FPSO (Floating Production Storage & Offloading) ships such as for example an extraction platform and a natural gas liquefaction unit, commonly referred to as an FLNG (Floating Liquefied Natural Gas) unit or an FSRU (Floating Storage and Regassification Unit), that is to say more generally a floating production, storage and export support. The sloshing phenomena occur equally under agitated sea conditions as under almost calm sea conditions if the liquefied gas cargo resonates with the excitation created by even a low swell to which the ship is subjected. In these cases of resonance the sloshing may become extremely violent, in particular in the event of waves breaking on the vertical walls or at the corners, therefore risking deterioration of the liquefied gas confinement system or the insulation system present just behind said confinement system.

Now the integrity of the tank is particularly important in the context of a liquefied gas tank, for example an LNG tank, by virtue of the inflammable or explosive nature of the liquid transported and the risk of cold spots on the steel hull of the floating unit in the event of a leak.

U.S. Pat. No. 8,643,509 discloses a method of reducing the risk linked to the sloshing of a liquefied gas cargo. In that document, a resonant frequency of the liquid in a tank is estimated as a function of the tank and its level of filling. During transport a frequency of movement of the ship is evaluated as a function of climatic and maritime conditions and from the speed of the ship. Forecast movement frequencies are also evaluated on the course that the ship is to follow. If any of the movement frequencies becomes too close to the resonant frequency of the liquid in a tank, an alarm is given to change course and/or to change the speed of the ship in order to avoid a hazardous situation.

Despite the provision of sloshing reduction measures, the sloshing of the liquids in the tanks, in particular because of resonance phenomena, can lead to localized risks of deformation of the primary sealing primary membrane, damage to the underlying structures present in the primary and/or secondary spaces on which the primary sealing membrane rests, falling objects, in particular from static equipment, liable to damage the primary sealing membrane in the short or medium term, or more generally from deformations of the primary sealing membrane exceeding its structural tolerances.

There is therefore still a need for methods for estimating a sloshing response of the tanks when the ship is sailing and if necessary for applying the necessary measures to prevent the occurrence of excessive sloshing risking damage to the primary sealing membrane of the tank.

### SUMMARY

One idea behind the invention is to use a supervised machine learning method to train a statistical model able to estimate a sloshing response of the tank as a function of a level of filling of the tank and of a current sea state and optionally of at least one of the following: a draft of the ship, a speed of the ship and a heading of the ship. The statistical model is trained on a set of test data obtained from results of a plurality of tests each consisting in subjecting a test tank having a given level of filling to movements and measuring a pressure at at least one point on a wall of the test tank and/or a number of impacts on at least one wall of the test tank. The statistical model can thereafter be used to estimate a sloshing response of a tank in the framework of a management system for a ship, for example by constructing a database that is usable for consultation in real time.

In accordance with an embodiment conforming to a first variant, the invention provides a method of obtaining a statistical model able to estimate a sloshing response of at least one sealed and thermally insulating tank for the transport of liquefied gas, the method comprising a step consisting in:

training a statistical model by a machine learning method supervised over a set of test data, the statistical model being able to estimate a sloshing response of the tank as a function of a level of filling of the tank and of a current sea state and optionally at least one of the following: a draft of the ship, a speed of the ship and a heading of the ship, and the set of test data being obtained from results of a plurality of tests each consisting in subjecting a test tank having a given level of filling to movements and measuring a pressure at at least one point on a wall of the test tank and/or a number of impacts on at least one wall of the test tank.

In accordance with an embodiment conforming to a second variant, the invention also provides a method of obtaining a statistical model able to estimate a sloshing response of at least one sealed and thermally insulating tank for the transport of liquefied gas, the method comprising a step consisting in:

training a statistical model by a supervised machine learning method on a set of test data, the statistical model being able to estimate a sloshing response of the tank as a function of a level of filling of the tank, of a current state of movement of the ship and optionally of at least one of the following: a draft of the ship, a speed of the ship and a heading of the ship, and the set of test data being obtained from results of a plurality of tests each consisting in subjecting a test tank having a given level of filling to movements and measuring a pressure at at least one point on a wall of the test tank and/or a number of impacts on at least one wall of the test tank.

By “supervised machine learning method” is meant a machine learning (also known in France as artificial learning or statistical learning) method consisting in learning a prediction function on the basis of annotated examples. In other words, a supervised machine learning method makes it possible to construct a model able to predict on the basis of a plurality of examples for which the response to be predicted is known. A supervised machine learning method is typically executed by a computer; thus the step consisting in training the statistical model is typically executed by a computer.

The statistical model to be trained in the context of the present invention is able to estimate a sloshing response that comprises one or more quantitative variables, at least as a function of a level of filling of the tank and of a current sea state or of a current state of movement of the ship. The statistical model to be trained is therefore able to address a regression problem.

Thanks to the step consisting in training the statistical model by a supervised machine learning method on the set of test data, the statistical model is able to estimate by calculation a sloshing response of a tank at least as a function of a level of filling of the tank and of a current sea state or of a current state of movement of the ship, including for values of the level of filling of the tank and for current sea states and states of movement of the ship for which no test has been carried out. The statistical model is therefore usable to estimate a sloshing response of a tank under real conditions of use on a ship.

The test tank may be smaller than the tank the sloshing response of which is to be estimated by the statistical model. It may have a geometry representative of the tank the sloshing response of which is to be estimated by the statistical model. It is moreover clear that in the phrase or feature “train a statistical model by a supervised method on a set of test data” the “set of test data” may also comprise or consist in data from so-called “real” campaigns, that is to say obtained or measured on ships in service as liquefied gas transport and/or user ships.

In accordance with embodiments, the methods described hereinabove may include one or more of the following features.

By sloshing response is meant any parameter and set of qualitative and/or quantitative parameters able to represent mechanical loads to which the tank is exposed during a phenomenon of sloshing of the cargo.

In accordance with one embodiment, the sloshing response comprises at least one of a number of impacts of fluid on the walls of the tank, a maximum pressure on the walls of the tank, and a probability of damage to the tank.

Thus the statistical model is able to estimate a probability of damage of the tank and/or a parameter enabling this kind of probability of damage to be estimated.

In accordance with one embodiment, the supervised machine learning method is a Gaussian process regression method.

A Gaussian process regression method is very suitable for training the statistical model because it enables production of a statistical model able to address a regression problem, for any set of input data, by training on the basis of a relatively limited amount of data. It is nevertheless possible to employ other supervised machine learning methods without departing from the scope of the present invention.

In accordance with one embodiment, at least one constraint is imposed on the statistical model during its training by the supervised machine learning method.

Thus the training of the statistical model may be guided on the basis of elementary physical considerations, for example the absence of sloshing in the situation where the level of filling of the tank is zero, and/or on the basis of considerations obtained through practical experience, for example the fact that greater movements or greater dimensions of the tank may potentially lead to a greater sloshing response. A result of this is that the accuracy of the estimate of the sloshing response by the statistical model is increased.

In accordance with one embodiment, the method further comprises step consisting in excluding from the set of test data test results featuring a sloshing response below a threshold before the step of training the statistical model.

Thus the statistical model is trained only on the basis of test data that has revealed serious sloshing, more particularly in terms of numbers of impacts. In effect, in accordance with one aspect of the invention, the number of occurrences encountered is a more important factor for statistical convergence than the intensity of the impacts. A result of this is that the accuracy of the estimate of the sloshing response by the statistical model is further increased.

In accordance with one embodiment, the statistical model considers a plurality of tanks, the statistical model being able to estimate a sloshing response of each tank as a function of its position in the ship.

In accordance with one embodiment conforming to the first variant, the invention also provides a system for obtaining a statistical model able to estimate a sloshing response of at least one sealed and thermally insulating tank for the transport of liquefied gas, the system comprising a processing means configured to train a statistical model by a supervised machine learning method on a set of test data, the statistical model being able to estimate a sloshing response of the tank as a function of a level of filling of the tank and of a current sea state and optionally of at least one of the following: a draft of the ship, a speed of the ship and a heading of the ship, and the set of test data being obtained from results of a plurality of tests each consisting in subjecting a test tank having a given level of filling to movements and measuring a pressure at at least one point on a wall of the test tank and/or a number of impacts on at least one wall of the test tank.

In accordance with an embodiment conforming to the second variant, the invention also provides a system for obtaining a statistical model able to estimate a sloshing response of at least one sealed and thermally insulating tank for the transport of liquefied gas, the system comprising a processing means configured to train a statistical model by a supervised machine learning method on a set of test data, the statistical model being able to estimate a sloshing response of the tank as a function of a level of filling of the tank, of a current state of movement of the ship and optionally of at least one of the following: a draft of the ship, a speed of the ship and a heading of the ship, and the set of test data being obtained from results of a plurality of tests each consisting in subjecting a test tank having a given level of filling to movements and measuring a pressure at at least one point on a wall of the test tank and/or a number of impacts on at least one wall of the test tank.

Such systems procure the same advantages as the methods described hereinabove.

In accordance with an embodiment conforming to the first variant, the invention also provides a method for obtaining a database usable to estimate a sloshing response of at least one sealed thermally insulating tank for the transport of liquefied gas, the method comprising the steps consisting in:

generating a plurality of input data vectors each comprising a level of filling of the tank and a current sea state; and
for each input data vector generated in this way: obtaining an estimated sloshing response of the tank with the aid of the statistical model obtained by the method described above conforming to the first variant and storing in a database the estimated sloshing response of the tank in association with the input data vector.

In accordance with an embodiment conforming to the second variant, the invention also provides a method for obtaining a database usable to estimate a sloshing response of at least one sealed thermally insulating tank for the transport of liquefied gas, the method comprising the steps consisting in:

generating a plurality of input data vectors each comprising a level of filling of the tank and a current state of movement of the ship; and
for each input data vector generated in this way: obtaining an estimated sloshing response of the tank with the aid of the statistical model obtained by the method described above conforming to the second variant and storing in a database the estimated sloshing response of the tank in association with the input data vector.

Although the statistical model is able to estimate by calculation a sloshing response of a tank for values of the level of filling and the tank and for current sea states or states of movement of the ship for which no test has been carried out, the calculation necessary to do this may be too long and/or necessitate too many calculation resources to be able to be used onboard a ship, where it is important to obtain an estimate of the sloshing response as quickly as possible and using an onboard system of the lowest possible cost. One idea behind these methods is therefore to carry out most of these calculations in advance on the basis of a plurality of input data vectors, which may be appropriately chosen to cover the entirety of a range of operation or functioning of the ship, and to store in a database the estimated sloshing response of the tank for each of those input data vectors in association with the input data vector. The estimated sloshing response of the tank can then be obtained either by simply reading the database if the input data vector is present in the database or by interpolation on the basis of the database otherwise. This requires much reduced calculation time and calculation resources than estimation based on the statistical model itself. The result of this is that the statistical model itself is not even necessary to effect the estimation of the statistical model onboard the ship, the database alone being sufficient. The estimate on the basis of the database can then be effected by a system onboard the ship, or even by a land station that communicates with the ship, for example by radio or via satellite.

In accordance with one embodiment, the invention also provides a database obtained by the methods of obtaining a database described hereinabove.

In accordance with one embodiment, the invention also provides a computer-readable storage medium on which is stored a database obtained by the methods of obtaining a database described hereinabove.

In accordance with an embodiment conforming to the first variant, the invention also provides a method for estimating a sloshing response of a sealed and thermally insulating tank for the transport of liquefied gas onboard a ship, the method comprising the steps consisting in:

determining a current level of filling of the tank;
determining a current sea state;
generating an input data vector comprising the current level of filling of the tank and the current sea state determined in this way; and
estimating a sloshing response of the tank from the input data vector generated in this way and from the database obtained by the method conforming to the first variant.

In accordance with an embodiment conforming to the second variant, the invention also provides a method for estimating a sloshing response of a sealed and thermally insulating tank for the transport of liquefied gas onboard a ship, the method comprising the steps consisting in:

determining a current level of filling of the tank;
determining a current state of movement of the ship;
generating an input data vector comprising the current level of filling of the tank and the current state of movement of the ship determined in this way; and
estimating a sloshing response of the tank from the input data vector generated in this way and from the database obtained by the method conforming to the second variant.

Thanks to these methods, it is possible to estimate a sloshing response of the tank thanks to the statistical model trained beforehand on the test database using the database. As mentioned hereinabove, this estimation necessitates much less calculation time and calculation resources than estimation on the basis of the statistical model itself, and can be effected by a system onboard the ship or by a land station that communicates with the ship.

In accordance with one embodiment, a plurality of tanks are considered and the method comprises a previous step of definition of the position of each of the tanks on the ship.

In accordance with one embodiment, the method further comprises a step consisting in furnishing an alarm to a user if the estimated sloshing response of the tank exceeds an alert threshold, and preferably a step of assisting the decision intended to reduce the sloshing. This decision assisting step may consist in a proposed change of direction or of course of the ship, a change of heading particularly suitable for stationary floating structures, modification of the speed of the ship or a change to the level of filling of the tank or tanks (between the tanks or between a tank and a storage facility external to the ship in the case of a stationary floating structure).

Moreover, the alarm may consist in reporting a problem to be corrected immediately or in the near future, if possible an alarm designating the tank or tanks from a plurality of tanks of a ship that necessitates an operation of inspection and maintenance with a view to a possible repair.

Thus a user such as a crew member is able to take any necessary measure to limit the sloshing in the tank if necessary, for example slowing or stopping the ship or changing the course of the ship, and therefore reducing the risk of damage to the tank.

In accordance with an embodiment conforming to the first variant, the invention also provides a management system for a ship including at least one sealed and thermally insulating tank for transporting liquefied gas, the system comprising:

at least one filling level sensor for measuring a current state of filling the one tank;
a device for evaluation of the sea state able to evaluate a current sea state; and
a processing means configured to generate an input data vector comprising a current level of filling of the tank and a current sea state evaluated by the sea state evaluation device and to estimate a sloshing response of the tank from the input data vector generated in this way and from the database obtained by the method conforming to the first variant.

In accordance with an embodiment conforming to the second variant, the invention also provides a management system for a ship including at least one sealed and thermally insulating tank for transporting liquefied gas, the system comprising:

at least one filling level sensor for measuring a current state of filling of the tank;
a device for evaluation of the current state of movement of the ship able to evaluate a current state of movement of the ship; and
a processing means configured to generate an input data vector comprising a current level of filling of the tank and a current state of movement of the ship and to estimate a sloshing response of the tank from the input data vector generated in this way and from the database obtained by the method conforming to the second variant.

Such systems procure the same advantages as the methods described hereinabove.

In accordance with one embodiment the processing means is further configured to furnish an alarm to a user if the estimated sloshing response of the tank exceeds an alert threshold and is preferably configured to furnish the user with assistance in making the decision intended to reduce the sloshing.

In accordance with another embodiment, the invention also provides a method of estimating a sloshing response of a sealed and thermally insulating tank for the transport of liquefied gas onboard a ship, the method comprising the steps consisting in:

determining a current level of filling of the tank;
estimating future sea states from meteorological information and a course of the ship;
generating a plurality of input data vectors each comprising a current level of filling of the tank and an estimated future sea state; and
estimating a future sloshing response of the tank from the input data vectors generated in this way and from the database obtained by the method conforming to the first variant.

According to the above method, it is possible to estimate a future sloshing response of the tank from meteorological information and a course of the ship, thanks to the statistical model trained beforehand on the basis of test data by means of the database. As mentioned hereinabove, this estimate necessitates much less calculation time and calculation resources than estimation on the basis of the statistical model itself, and may be effected by a system onboard the ship or by a land station that communicates with the ship.

In accordance with another embodiment, the invention also provides a method of estimating a sloshing response of a sealed and thermally insulating tank for the transport of liquefied gas onboard a ship, the method comprising the steps consisting in:

determining a current level of filling of the tank;
estimating future states of movement of the ship from meteorological information and a course of the ship;
generating a plurality of input data vectors each comprising a current level of filling of the tank and an estimated future state of movement of the ship; and
estimating a future sloshing response of the tank from the input data vectors generated in this way and from the database obtained by the method conforming to the second variant.

In accordance with one embodiment, the method further comprises a step consisting in determining a course of the ship and/or a modification of the level of filling of the tank enabling reduction of the future sloshing response of the tank. There is meant by the expression “course of the ship” a heading of that ship, the speed of the latter or simple avoidance of a geographical zone. For stationary floating structures (ships, barges), that is to say those at a fixed position, the change of heading is reflected in a change of angle between the North direction and the longitudinal axis of the structure in such a manner as to orient or to bring about the floating structure to reduce in the conventional way the negative consequences of the swell and the waves on the floating structure.

Thus a user such as a crew member is able to take the decision to cause the ship to follow a course enabling reduction of the future sloshing response of the tank and thus to reduce the risk of damage to the tank.

In accordance with another embodiment, the invention also provides a management system for a ship including at least one sealed and thermally insulating tank for transporting liquefied gas, the system comprising:

at least one level of filling sensor for measuring a current level of filling of the tank;
a sea state estimation device able to estimate future sea states from meteorological information and from a course of the ship; and
a processing means configured to a generate a plurality of input data vectors each comprising a current level of filling of the tank and a future sea state estimated by the sea state estimation device, and to estimate a future sloshing response of the tank from the input data vectors generated in this way and from the database obtained by the method conforming to the first variant.

In accordance with another embodiment, the invention also provides a management system for a ship including at least one sealed and thermally insulating tank for transporting liquefied gas, the system comprising:

at least one level of filling sensor for measuring a current level of filling of the tank;
a state of movement estimation device able to estimate future states of movement of the ship from meteorological information and from a course of the ship; and
a processing means configured to a generate a plurality of input data vectors each comprising a current level of filling of the tank and a future state of movement of the ship estimated by the state of movement of the ship estimation device, and to estimate a future sloshing response of the tank from the input data vectors generated in this way and from the database obtained by the method conforming to the second variant.

In accordance with one embodiment the processing means is further configured to determine a course of the ship enabling reduction of the future sloshing response of the tank.

### BRIEF DESCRIPTION OF THE FIGURES

The invention will be better understood and other aims, details, features and advantages thereof will become more clearly apparent in the course of the following description of particular embodiments of the invention given by way of nonlimiting illustration only with reference to the appended drawings.

FIG. 1 is a diagrammatic representation of a liquefied gas transport ship.

FIG. 2 represents a management system integrated into the ship from FIG. 1.

FIG. 3 represents a management system in accordance with another embodiment.

FIG. 4 is a diagrammatic representation of a test tank sloshing response test device.

FIG. 5 is a flow chart representing a method of obtaining a database usable to estimate a sloshing response of a tank.

FIG. 6 is a flow chart representing a method of estimating a sloshing response of a tank.

FIG. 7 is a flow chart representing another method of estimating a sloshing response of a tank.

FIG. 8 is a flow chart representing a further method of estimating a sloshing response of a tank.

### DESCRIPTION OF EMBODIMENTS

The embodiments hereinafter are described with reference to a ship including a double hull forming a supporting structure in which are arranged a plurality of sealed and thermally insulating tanks. In this kind of supporting structure the tanks have for example a polyhedral geometry, for example of prismatic shape.

Such sealed and thermally insulating tanks are provided for example for the transport of liquefied gas. The liquefied gas is then transported in such tanks at a low temperature that necessitates thermally insulating tank walls in order to maintain the liquefied gas at that temperature. It is therefore particularly important to maintain intact the integrity of the tank walls, including the thermal insulation spaces situated under the sealing membrane, on the one hand to preserve the seal of the tank and to avoid leaks of liquefied gas from the tanks and, on the other hand, to prevent the insulating characteristics of the tank from being degraded in order to maintain the gas in its liquefied form.

Such sealed and thermally insulating tanks also include an insulating barrier anchored to the double hull of the ship and carrying at least one sealed membrane. By way of example, such tanks may be produced in accordance with the technologies marketed under the trade marks Mark III® or NO96® of the applicant, or others.

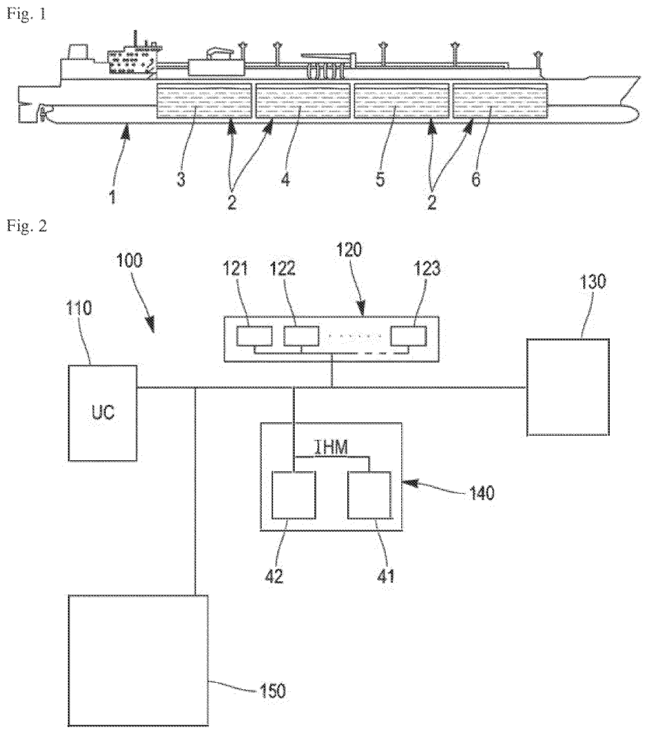

FIG. 1 illustrates a ship 1 including four sealed and thermally insulating tanks 2. The four tanks 2 may have identical or different filling states. When it is at sea the ship 1 is subjected to numerous movements linked to the sailing conditions. These movements of the ship 1 are transmitted to the liquid contained in the tanks 3, 4, 5, 6 which consequently is subject to movements in the tanks 3, 4, 5, 6. These movements of the liquid in the tanks 3, 4, 5, 6 generate impacts on the walls of the tanks 3, 4, 5, 6 that can damage the tanks immediately if they are too violent. Moreover, the repeated hammering of the walls of the tanks 3, 4, 5, 6 at high and non-destructive levels can lead to said walls being degraded by wear due to fatigue. Now, it is important to preserve the integrity of the walls of tanks 3, 4, 5, 6 to preserve the seal and the insulation characteristics of the tanks 3, 4, 5, 6.

It is known to avoid critical navigation conditions to prevent movements of liquid that risk damaging the tank immediately. However, there still exists a need for methods enabling a sloshing response of the tanks to be estimated when the ship is sailing and if necessary to take the measures necessary to prevent the appearance of excessive sloshing risking damage to the primary sealing membrane of the tank.

FIG. 2 illustrates an example of a management system 100 onboard the ship 1. This management system 100 includes a central processor unit 110 connected to a plurality of onboard sensors 120 enabling various parameter measurements to be obtained. Thus the sensors 120 include, for example and not exhaustively, at least one filling level sensor 121, for each tank, various sensors 122 of movements of the ship and maritime condition sensors 123. The management system 100 also includes a communication interface 130 enabling the central processor unit 110 to communicate with remote devices, for example to obtain meteorological data, ship position data or other data.

The ship movement sensors 122 determine measured movements of the ship, for example by measuring the accelerations to which the ship is subjected on three perpendicular axes in translation and in rotation. To assess the movements of the ship an inertial measurement unit (IMU) can advantageously be used that consists in one or more accelerometers and/or one or more gyroscopes, for example mechanical gyroscopes, and/or one or more magnetometers. On the assumption that a plurality thereof are used (of the same type or of two different types), these measuring units are advantageously distributed over the ship in such a manner as to produce a precise measurement of the movement of the ship. It will be noted that an IMU is sometimes commonly referred to as a motion reference unit (MRU).

The maritime condition sensors 123 obtain a current sea state in the environment of the ship, for example a height and a frequency of the waves in the environment of the ship. For example, in one embodiment the height and/or the frequency of the waves are obtained from visual observation by the crew.

The management system 100 further includes a human-machine interface 140. This human-machine interface 140 includes a display means 41. That display means 41 enables the operator to obtain the management information calculated by the system or the measurements obtained by the sensors 120 or even a current sloshing state, which can be estimated as described in detail hereinafter.

The human-machine interface 140 further includes an acquisition means 42 enabling the operator manually to provide magnitudes to the central processor unit 110, typically to furnish the central processor unit 110 with data that cannot be obtained by sensors because the ship does not include the necessary sensor or the latter is damaged. For example, in one embodiment the acquisition means enables the operator to enter information on the height and/or the frequency of the waves on the basis of visual observation and/or to enter manually a heading and/or a speed of the ship.

The management system 100 further includes a database 150. That database is usable to estimate a sloshing response of a tank as will be described in detail below.

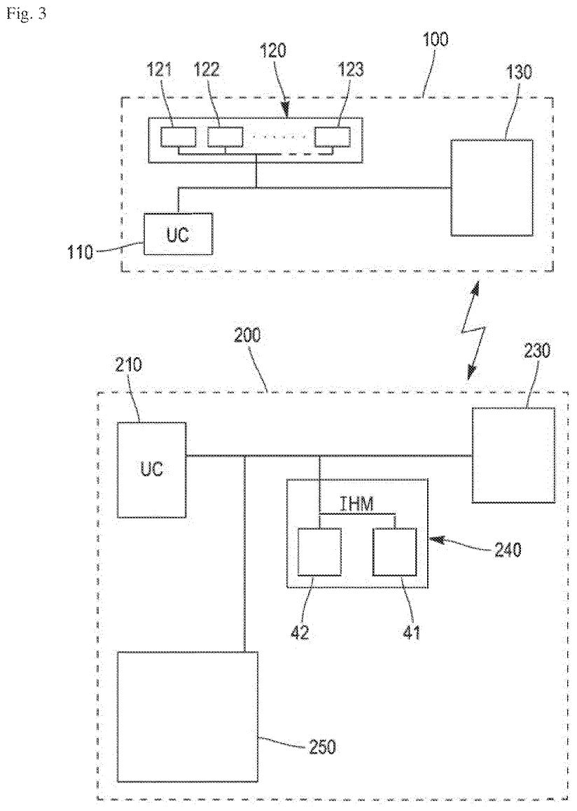

FIG. 3 illustrates an example of a management system 200 situated on the land and communicating with the ship 1. The ship includes the central processor unit 110, the sensors 120 and a communication interface 130. The management unit 200 includes a central processor unit 210, a communication interface 230, a human-machine interface 240 and a database 250. The functioning of the management system 200 is similar to the functioning of the management system 100 and differs therefrom only in the sending of information measured by the sensors 120 on the ship 1 to the management system 200 situated on land via the communication interfaces 130 and 230. For example, the communication interfaces may employ terrestrial or satellite radio transmission of data.

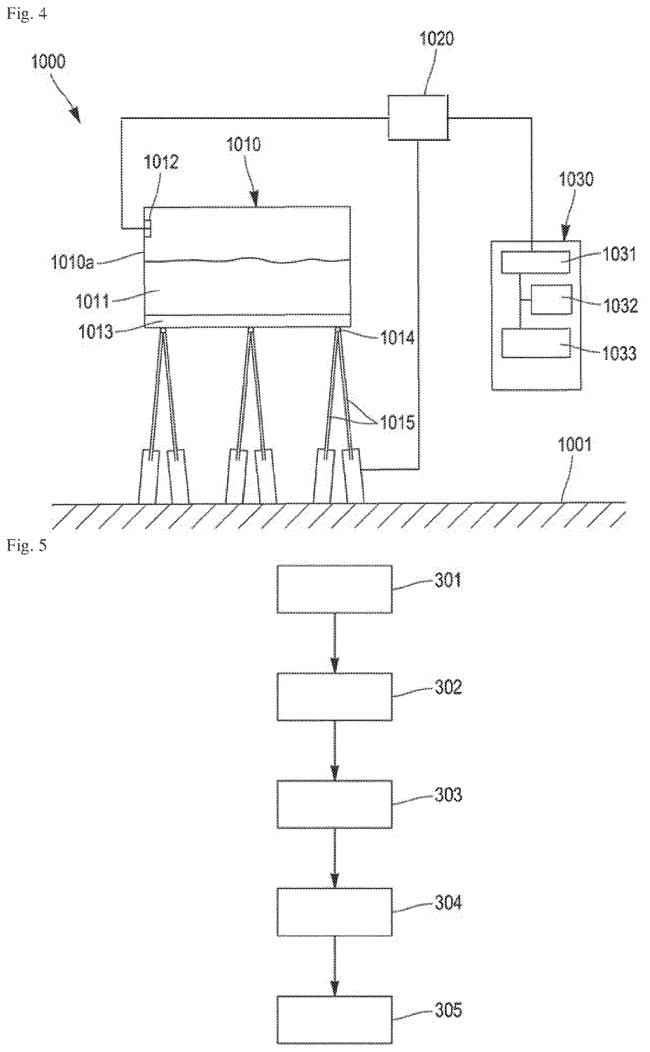

How the database 150 is obtained will now be described with the aid of FIGS. 4 and 5.

FIG. 4 represents diagrammatically an example of a test device 1000 enabling tests to be carried out on a test tank 1010. The tests consist in subjecting the test tank 1010 to movements, the test tank 1010 having a given level of filling with a fluid 1011, and measuring a pressure at at least one point on a wall 1010a of the test tank 1010 using a pressure sensor 1012 and/or a number of impacts on at least one wall of the test tank 1010.

The test tank 1010 may be small compared to a tank the sloshing response of which is to be estimated and/or have a geometry representative of the tank a sloshing response whereof is to be determined.

Of course, the fluid 1011 is preferably of the same nature and ideally has the same temperature, density, viscosity as that transported by the tank a sloshing response whereof is to be determined; it may in particular be liquefied petroleum gas (LPG) at for example a temperature between −50° C. and 0° C. or liquefied natural gas (LNG) at approximately −162° C. at atmospheric pressure. Numerous liquefied gases may also be envisaged, in particular methane, ethane, propane, butane, ammonia gas, dihydrogen or ethylene.

Moreover, it is possible to measure a pressure at a plurality of points on a wall 1010a of the test tank 1010 or even several or all of those walls, the number and the arrangement of the pressure sensors 1012 being adapted accordingly. If a number of impacts on at least one wall of the test tank 1010 is measured, that measurement is effected with the aid of a plurality of pressure sensors 1012 appropriately arranged on that wall. It is possible to measure a number of impacts on a plurality of walls of the test tank 1010 or on all the walls of the test tank 1010.

As mentioned above, the test tank 1010 is subjected to movements during the tests. In the example represented the device 1000 therefore comprises a platform 1013 to which the test tank 1010 is secured. The platform 1013 is driven in movement by the action of six hydraulic rams 1015 connected at one of their ends to the platform at three fixing points 1014 and at the other end to a frame or to the ground 1001. This enables the test tank 1010 to be driven in movement with six degrees of freedom in translation and in rotation. Of course, the test tank 1010 may be driven in movement by different means.

The device 1000 further comprises a test control unit 1020. The test control unit 1020 is configured to control the hydraulic rams 1015 in order to subject the test tank 1010 to predetermined movements in a test program. In one embodiment these movements are movements representing a given movement of the ship that preferably take account of the position of the tank on the ship and/or of the geometry of the tank. In another embodiment these movements are movements representing a given sea state, which are converted into corresponding movements of the ship, preferably taking account of the position of the tank on the ship and/or of the geometry of the tank. Evaluation of the corresponding movements of the ship on the basis of a given sea state is a routine task in the evaluation of the seaworthiness of a ship. Moreover, the test control unit 1020 stores the values measured during the tests by at least one pressure sensor 1012.

The test control unit 1020 communicates with a test data processing unit 1030. The test data processing unit 1030 comprises a communication interface 1031 enabling reception from the test control unit 1020 of the values measured during the test by the at least one pressure sensor 1012 and the movements imposed on the test tank 1010 during the test. The test data processing unit 1030 further comprises a memory 1033 and a central processor unit 1032.

The test data processor unit 1030 is configured to train by a machine learning method a statistical model in the central processor 1032 communicating with the memory 1033. The statistical model is able to estimate a sloshing response of the tank as a function of a level of filling of the tank and of a current sea state and optionally of at least one of the following: a draft of the ship, a speed of the ship and a heading of the ship. The sloshing response comprises at least one of the following: a number of impacts of fluid on the walls of the tank, a maximum pressure on the walls of the tank, and a probability of damaging the tank. In a variant the statistical model considers a plurality of tanks, the statistical model being able to estimate a sloshing response of each tank as a function of its position on the ship.

More specifically, the statistical model is trained by a supervised machine learning method. For example, the supervised machine learning method may be a Gaussian process regression method. Gaussian progress regression methods are well known in themselves; they are well suited to training the statistical model because they enable a statistical model to be produced able to address a regression problem, for any set of input data, by training on the basis of a relatively limited quantity of data. Nevertheless, it is possible to adopt other supervised machine learning methods.

The statistical model is trained on the basis of the test results produced using the test tank 1010. More specifically, in a preferred example the statistical model is trained on the basis of the sloshing response of the test tank 1010 during each test, that sloshing response being calculated beforehand on the basis of the values measured during the test by the at least one pressure sensor 1012. The sloshing response of the test tank 1010 may comprise at least one of the following: a number of fluid impacts on one or some of the walls 1010a of the test tank 1010 and a maximum pressure on the walls 1010a of the test tank 1010 over a given period. In a variant the statistical model is trained both on the basis of the results of the tests carried out on the test tank 1010 and of test data obtained or measured on ships in service as liquefied gas transporters and/or users, one or more tanks of those ships playing the role of the test tank 1010. In another variant the statistical model may be trained only on the basis of test data obtained or measured on ships in service as liquefied gas transporters and/or users, one or more tanks of those ships playing the role of the test tank 1010.

A method 300 enabling the database 150 to be obtained will now be described with the aid of FIG. 5. The steps 301 to 305 may be executed by the central processor unit 1032 communicating with the memory 1033.

The method 300 may optionally comprise a step 301 consisting in a excluding from the set of test data used to train the statistical model any test results showing a sloshing response of the test tank 1010 below a certain threshold. The statistical model is therefore trained only on the basis of test data that has revealed significant sloshing in the test tank 1010, which improves the accuracy of the estimate of the sloshing response using the statistical model.

After the optional step 301, the method 300 comprises a step 302 consisting in training the statistical model as already described hereinabove.

At least one constraint is optionally imposed on the statistical model during training thereof by the supervised machine learning method during the step 302. Those constraints may be defined on the basis of elementary physical considerations, for example the absence of sloshing in the situation where the filling level of the tank is zero, and/or on the basis of considerations obtained through practical experience, for example the fact that greater movements or larger dimensions of the tank can potentially lead to a higher sloshing response. The result of this is that the accuracy of the estimate of the sloshing response by the statistical model is increased.

On completion of the step 302 a statistical model is obtained that is able to estimate a sloshing response of the tank as a function of the level of filling of the tank and of a current sea state and optionally of at least one of the following: a draft of the ship, a speed of the ship and a heading of the ship, for any values of those magnitudes, including those for which no test has been carried out on the test tank 1010. Nevertheless, the calculation necessary to do this may be too long and/or necessitate too great calculation resources to be able to be implemented onboard a ship for which it is important to obtain an estimate of the sloshing response as quickly as possible and using an onboard system of the lowest possible cost. This is why, after the step 302, there is used a step 303 consisting in generating a plurality of input data vectors each comprising a level of filling of the tank and a current sea state, followed by a step 304 consisting in, for each input data vector generated in the step 303: obtaining an estimated sloshing response of the tank with the aid of the statistical model in the step 302 and storing in a database the estimated sloshing response of the tank with the associated input data vector.

In a step 305 the database obtained in the step 304 is optionally transmitted to the management system 100 or stored on a computer-readable storage medium. The database 150 is also obtained, the use of which will be described below.

Until now there has been described a situation in which the statistical model is able to estimate a sloshing response of the tank as a function of at least a level of filling of the tank and of a current sea state. Nevertheless, in a variant the statistical model is able to estimate a sloshing response of the tank as a function of a filling level of the tank, of a current state of movement of the ship and optionally of at least one of the following: a draft of the ship, a speed of the ship and a heading of the ship. The steps 302, 303, 304 are then modified accordingly.

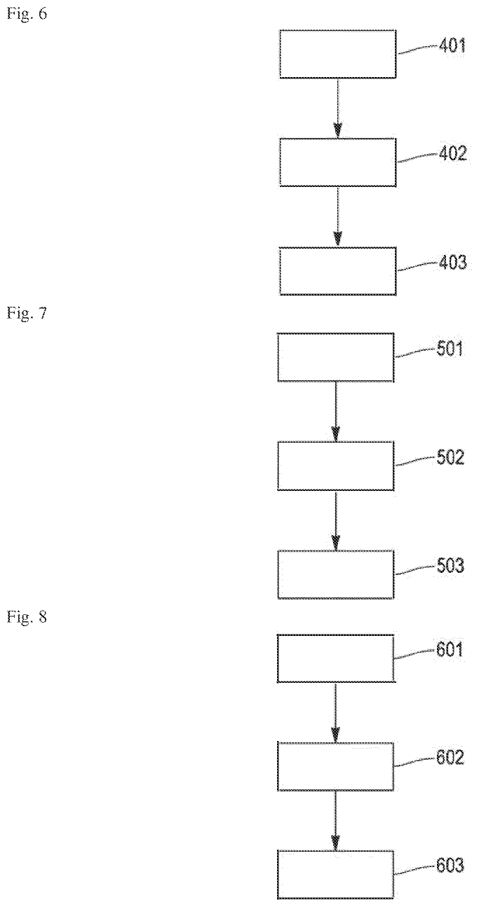

There will now be described with the aid of FIG. 6 a method 400 of estimating a sloshing response of a tank with the aid of the database 150. The method 400 may consider a plurality of tanks instead of only one tank. In this case, before the method 400 is executed, a preliminary step of defining the position of each of the tanks on the ship may be carried out.

In accordance with a first embodiment the FIG. 6 flow chart is executed entirely in the central processor unit 110 forming a single processing means. In accordance with a second embodiment the FIG. 6 flow chart is partly executed in the land management system 200 that communicates with the ship. In accordance with this second embodiment the ship 1 transmits to the land station all the information coming from the sensors 120 and the central processor unit 110 and the central processor unit 210 together form a shared processing means.

The method 400 comprises a first step 401 consisting in determining a current level of filling of the tank and a current sea state. The current level of filling of the tank is typically determined on the basis of a filling indication supplied by the filling level of the tank sensor 121. The current sea state may be determined from indications furnished by the maritime condition sensors 123 and/or by terrestrial or satellite radio communication with a network of weather stations.

In the step 401 there is optionally also determined a draft of the ship and/or a heading of the ship, typically on the basis of indications furnished by the onboard systems of the ship. The draft of the ship is typically furnished to the onboard systems of the ship by one or more float and/or hydrostatic pressure type sensors. The heading of the ship is typically furnished to the onboard systems of the ship by one or more navigation compasses.

The method 400 further comprises a second step 402 consisting in generating an input data vector comprising the data determined in the step 401.

The method 400 further comprises a third step 403 consisting in estimating a sloshing response of the tank on the basis of the input data vector generated in the step 402 and the database 150. In more concrete terms, if it proves that the input data vector is present in the database 150, the sloshing response is obtained by simply reading the database 150. Nevertheless, the database 150 will typically not contain the input data vector, but rather input data close to that contained in the input data vector. In this instance the sloshing response will be obtained by interpolation from the sloshing response associated with two or more adjacent input data vectors present in the database 150.

After the step 403 the sloshing response obtained can be compared to an alert threshold and an alarm may be displayed to a user, for example on the display means 41, if the sloshing response exceeds the alert threshold. The display of this alarm, is preferably followed by a step of assisting making the decision intended to reduce sloshing. This decision assistance step may consist in a proposed change of direction or of course of the ship, in a change of heading particularly suitable for stationary floating structures, in a modification of the speed of the ship or a change of the level of filling of the tank or tanks (between the tanks or between a tank and a storage facility external to the ship in the case of a stationary floating structure). Moreover, the alarm may consist in reporting a problem to be corrected immediately or in the short term, if possible an alarm designating the tank or tanks necessitating an inspection and maintenance operation with a view to a possible repair.

Another method 500 of estimating a sloshing response of a tank with the aid of the database 150 will now be described with the aid of FIG. 7. In this variant the database 150 is obtained from a statistical model that is able to estimate a sloshing response of the tank as a function of a level of filling of the tank, of a current state of movement of the ship and optionally of at least one of the following: a draft of the ship, a speed of the ship and a heading of the ship, as described above with reference to FIG. 4. The method 500 may consider a plurality of tanks instead of only one tank. In this case, before executing the method 500 there may be a previous step to define the position of each of the tanks on the ship.

The method 500 comprises a first step 501 consisting in determining a current level of filling of the tank and a current state of movement of the ship. The current level of filling of the tank is typically determined on the basis of a filling indication furnished by the level of filling of the tank sensor 121. The current state of movement of the ship may be determined on the basis of indications furnished by the ship movement sensors 122.

In the step 501 there is optionally also determined a draft of the ship and/or a heading of the ship, typically on the basis of indications furnished by the onboard systems of the ship. The draft of the ship is typically furnished to the onboard systems of the ship by one or more float and/or hydrostatic pressure type sensors. The heading of the ship is typically furnished to the onboard systems of the ship by one or more navigation compasses.

The ship movement sensors 122 typically having an acquisition frequency very much higher than the typical duration of evolution of the sloshing of the tank, the indications furnished by the ship movement sensors 122 may be averaged over an acquisition period, the other data determined in the step 501 then being averaged over that same acquisition period.

The method 500 further comprises a second step 502 analogous to the step 402 consisting in generating an input data vector comprising the data determined in the step 501.

The method 500 further comprises a third step 503 consisting in estimating a sloshing response of the tank on the basis of the input data vector generated in the step 502 and the database 150. The step 503 is analogous to the step 403 and is therefore not explained in detail again.

After the step 503 the sloshing response obtained may be compared to an alert threshold and an alarm may be displayed to the user, for example on the display means 41, if the sloshing response exceeds the alert threshold. After displaying that alarm, there may preferably follow a step of assisting making the decision intended to reduce sloshing. This decisionmaking assistance step may consist in a proposed change of direction or of course of the ship, in a change of heading particularly suitable for stationary floating structures, of a modification of the speed of the ship or a change in the level of filling of the tank or tanks (between the tanks or between a tank and a storage facility external to the ship in the case of a stationary floating structure). Moreover, the alarm may consist in reporting a problem to be corrected immediately or in the short term, if possible an alarm designating the tank or tanks necessitating an inspection and maintenance operation with a view to possible repair.

Another method 600 of estimating a sloshing response of a tank with the aid of the database 150 will now be described with the aid of FIG. 8. In this variant the database 150 is obtained from a statistical model that is able to estimate a sloshing response of the tank as a function of a level of filling of the tank, of a current sea state and optionally of at least one of the following: a draft of the ship, a speed of the ship and a heading of the ship.

The method 600 comprises a first step 601 consisting in determining a current level of filling of the tank and estimating future sea states. The current level of filling of the tank is typically determined on the basis of a filling indication furnished by the tank filling level sensor 121. The future sea states are estimated on the basis of meteorological information and of a course of the ship. The course of the ship is typically obtained from indications furnished by the onboard systems of the ship, such as the speed of the ship and the heading of the ship. The meteorological information may be furnished by the maritime condition sensors 123 and/or by terrestrial or satellite radio communication with a network of weather stations.

The method 600 further comprises a second step 602 consisting in generating a plurality of input data vectors each comprising a current level of filling of the tank and an estimated future sea state.

In the step 601 there are optionally also determined a draft of the ship, a heading of the ship and a speed of the ship, typically from indications furnished by the onboard systems of the ship. The draft of the ship is typically furnished to the onboard systems of the ship by one or more float and/or hydrostatic pressure type sensors. The heading of the ship is typically furnished to the onboard systems of the ship by one or more navigation compasses. The speed of the ship is typically furnished to the onboard systems of the ship by an IMU and/or by a GPS type satellite navigation receiver.

The method 600 further comprises a third step 603 consisting in estimating a future sloshing response of the tank from each of the input data vectors generated in the step 602 and the database 150. The step 603 is analogous to the step 403 and is therefore not explained in detail again.

After the step 603 a course of the ship may be determined enabling reduction of the future sloshing response of the tank relative to the sloshing response of the ship that would come about if the ship maintained its current course. By the expression “ship's course” is meant a heading of that ship, the speed of the latter or a simple avoidance of a geographical zone. For stationary floating structures (ships, barges), that is to say those having a fixed position, the change of bearing is a change of angle between the North direction and the longitudinal axis of the structure in such a manner as to orient or bring about the floating structure to reduce in the classic way the negative consequences of the swell and the waves on the floating structure. Additionally or alternatively, a modification of the level of filling of the tank may be determined enabling reduction of the future sloshing response of the tank.

A variant of the method 600 from FIG. 8 is described hereinafter. In that variant the database 150 is obtained from a statistical model that is able to estimate a sloshing response of the tank as a function of a level of filling of the tank, of a current state of movement of the ship and optionally of at least one of the following: a draft of the ship, a speed of the ship and a heading of the ship.

In this variant the step 601 consists in determining a current level of filling of the tank and estimating future states of movement of the ship. The current level of filling of the tank is typically determined from a filling indication furnished by the tank level of filling sensor 121. The future states of movement of the ship are estimated from meteorological information and from a course of the ship. The course of the ship is typically obtained from indications furnished by the onboard systems of the ship, such as the speed of the ship and the heading of the ship. The meteorological information may be furnished by the maritime condition sensors 123 and/or by terrestrial or satellite radio communication with a network of weather stations. In accordance with one example the future states of movement of the ship may be estimated by initially estimating future sea states that are estimated from meteorological information and a course of the ship, then in a second step by estimating future states of movement of the ship from the future sea states estimated in this way. Remember that, as already mentioned hereinabove, a valuation of the corresponding movements of the ship on the basis of a given sea state is a routine task in the evaluation of the seaworthiness of a ship.

The step 602 then consists in generating a plurality of input data vectors each comprising a current level of filling of the tank and an estimated future state of movement of the ship.

In the step 601 there is also optionally determined a draft of the ship, a heading of the ship and a speed of the ship, as already mentioned above.

The step 603 consists in estimating a future sloshing response of the tank from each of the input data vectors generated in the step 602 and from the database 150. The step 603 is analogous to the step 403 and is therefore not explained in detail again.

After the step 603 there may be determined a course of the ship enabling reduction of the future sloshing response of the tank relative to the sloshing response of the tank that would come about if the ship maintained its current course, as already mentioned above.

Although the invention has been described in connection with a plurality of particular embodiments, it is obvious that it is in no way limited to the latter and that it encompasses all technical equivalents of the means described and combinations thereof if the latter fall within the scope of the invention.

Moreover, it is obvious that a feature or a combination of features described with reference to one method applies just as much to a corresponding system and vice versa.

Use of the verb “include”, “comprise” and conjugate forms thereof does not exclude the presence of elements or steps other than those set out in a claim.

In the claims, any reference sign between parentheses should not be interpreted as a limitation of the claim.

1. A method of obtaining a statistical model able to estimate a sloshing response of at least one sealed and thermally insulated tank for the transport of liquefied gas, the method comprising a step (302) consisting in:
training a statistical model by a supervised machine learning method on a set of test data, the statistical model being able to estimate a sloshing response of the tank as a function of a level of filling of the tank and of a current sea state and optionally at least one of the following: a draft of the ship, a speed of the ship and a heading of the ship, and the set of test data being obtained from results of a plurality of tests each consisting in subjecting a test tank (1010) having a given level of filling to movements and measuring a pressure at at least one point on a wall (1010a) of the test tank (1010) and/or a number of impacts on at least one wall of the test tank (1010).

2. A method of obtaining a statistical model able to estimate a sloshing response of at least one sealed and thermally insulated tank for the transport of liquefied gas, the method comprising a step (302) consisting in:
training a statistical model by a supervised machine learning method on a set of test data, the statistical model being able to estimate a sloshing response of the tank as a function of a level of filling of the tank, a current state of movement of the ship and optionally of at least one of the following: a draft of the ship, a speed of the ship and a heading of the ship, and the set of test data being obtained from results of a plurality of tests each consisting in subjecting a test tank (1010) having a given level of filling to movements and measuring a pressure at at least one point on a wall (1010a) of the test tank (1010) and/or a number of impacts on at least one wall of the test tank (1010).

3. The method according to claim 1, in which the sloshing response comprises at least one of a number of impacts of fluid on the walls of the tank, a maximum pressure on the walls of the tank, and a probability of damage to the tank.

4. The method according to claim 1, in which the supervised machine learning method is a Gaussian process regression method.

5. The method according to claim 1, in which at least one constraint is imposed on the statistical model during its training by the supervised machine learning method.

6. The method according to claim 1, further comprising a step (301) consisting in excluding from the set of test data test results featuring a sloshing response below a threshold before the step (302) of training the statistical model.

7. The method according to claim 1, in which the statistical model considers a plurality of tanks, the statistical model being able to estimate a sloshing response of each tank as a function of its position in the ship.

8. A system (1030) for obtaining a statistical model able to estimate a sloshing response of at least one sealed and thermally insulating tank for the transport of liquefied gas, the system (1030) comprising a processing means (1032, 1033) configured to train a statistical model by a supervised machine learning method on a set of test data, the statistical model being able to estimate a sloshing response of the tank as a function of a level of filling of the tank and of a current sea state and optionally at least one of the following: a draft of the ship, a speed of the ship and a heading of the ship, and the set of test data being obtained from results of a plurality of tests each consisting in subjecting a test tank (1010) having a given level of filling to movements and measuring a pressure at at least one point on a wall (1010a) of the test tank (1010) and/or a number of impacts on at least one wall of the test tank (1010).

9. A system (1030) for obtaining a statistical model able to estimate a sloshing response of at least one sealed and thermally insulating tank for the transport of liquefied gas, the system (1030) comprising a processing means (1032, 1033) configured to train a statistical model by a supervised machine learning method on a set of test data, the statistical model being able to estimate a sloshing response of the tank as a function of a level of filling of the tank, of a current state of movement of the ship and optionally of at least one of the following: a draft of the ship, a speed of the ship and a heading of the ship, and the set of test data being obtained from results of a plurality of tests each consisting in subjecting a test tank (1010) having a given level of filling to movements and measuring a pressure at at least one point on a wall (1010a) of the test tank (1010) and/or a number of impacts on at least one wall of the test tank (1010).

10. The method (300) for obtaining a database (150) usable to estimate a sloshing response of at least one sealed thermally insulating tank for the transport of liquefied gas, the method comprising the steps consisting in:
generating (303) a plurality of input data vectors each comprising a level of filling of the tank and a current sea state; and
for each input data vector generated in this way: obtaining (303) an estimated sloshing response of the tank with the aid of the statistical model obtained by the method according to claim 1, and storing (303) in a database the estimated sloshing response of the tank in association with the input data vector.

11. The method (300) for obtaining a database (150) usable to estimate a sloshing response of at least one sealed thermally insulating tank for the transport of liquefied gas, the method comprising the steps consisting in:
generating (302) a plurality of input data vectors each comprising a level of filling of the tank and a current state of movement of the ship; and
for each input data vector generated in this way: obtaining (303) an estimated sloshing response of the tank with the aid of the statistical model obtained by the method according to claim 2, and storing (303) in a database the estimated sloshing response of the tank in association with the input data vector.

12. The method (400) for estimating a sloshing response of at least one sealed and thermally insulating tank for the transport of liquefied gas onboard a ship, the method comprising the steps consisting in:
determining (401) a current level of filling of the tank;
determining (401) a current sea state;
generating (402) an input data vector comprising the current level of filling of the tank and the current sea state determined in this way; and
estimating (403) a sloshing response of the tank from the input data vector generated in this way and from the database (150) obtained by the method according to claim 10.

13. The method (500) for estimating a sloshing response of at least one sealed and thermally insulating tank for the transport of liquefied gas onboard a ship, the method comprising the steps consisting in:
determining (501) a current level of filling of the tank;
determining (501) a current state of movement of the ship;
generating (502) an input data vector comprising the current level of filling of the tank and the current state of movement of the ship determined in this way; and
estimating (503) a sloshing response of the tank from the input data vector generated in this way and from the database (150) obtained by the method according to claim 11.

14. The method according to claim 12, in which a plurality of tanks are considered and the method comprises a previous step of definition of the position of each of the tanks of the ship.

15. The method (400, 500) according to claim 12, further comprising a step consisting in furnishing an alarm to a user if the estimated sloshing response of the tank exceeds an alert threshold, and preferably a step of assisting the decision intended to reduce the sloshing.

16. A management system (100) for a ship (1) including at least one sealed and thermally insulating tank (2) for transporting liquefied gas, the system comprising:
at least one filling level sensor (121) for measuring a current state of filling of the tank (2);
a device (123) for evaluation of the sea state able to evaluate a current sea state; and
a processing means (110) configured to generate an input data vector comprising a current level of filling of the tank and a current sea state evaluated by the sea state evaluation device (123) and to estimate a sloshing response of the tank (2) from the input data vector generated in this way and from the database (150) obtained by the method (300) according to claim 10.

17. The management system (100) for a ship (1) including at least one sealed and thermally insulating tank (2) for transporting liquefied gas, the system comprising:
at least one filling level sensor (121) for measuring a current state of filling of the tank (2);
a device (122) for evaluation of the current state of movement of the ship able to evaluate a current state of movement of the ship; and
a processing means (110) configured to generate an input data vector comprising a current level of filling of the tank and a current state of movement of the ship and to estimate a sloshing response of the tank from the input data vector generated in this way and from the database (150) obtained by the method according to claim 11.

18. The method (600) of estimating a sloshing response of a sealed and thermally insulating tank (2) for the transport of liquefied gas onboard a ship (1), the method comprising the steps consisting in:
determining (601) a current level of filling of the tank;
estimating (601) future sea states from meteorological information and a course of the ship;
generating (602) a plurality of input data vectors each comprising a current level of filling of the tank and an estimated future sea state; and
estimating (603) a future sloshing response of the tank from the input data vectors generated in this way and from the database (150) obtained by the method according to claim 10.

19. The method (600) of estimating a sloshing response of a sealed and thermally insulating tank (2) for the transport of liquefied gas onboard a ship (1), the method comprising the steps consisting in:
determining (601) a current level of filling of the tank;
estimating (601) future states of movement of the ship from meteorological information and a course of the ship;
generating (602) a plurality of input data vectors each comprising a current level of filling of the tank and an estimated future state of movement of the ship; and
estimating (603) a future sloshing response of the tank from the input data vectors generated in this way and from the database (150) obtained by the method according to claim 11.

20. The method according to claim 18, further comprising a step consisting in determining a course of the ship and/or a modification of the level of filling of the tank enabling reduction of the future sloshing response of the tank.

21. The management system (100) for a ship (1) including at least one sealed and thermally insulating tank (2) for transporting liquefied gas, the system comprising:
at least one level of filling sensor (121) for measuring a current level of filling of the tank (2);
a sea state estimation device (123) able to estimate future sea states from meteorological information and from a course of the ship (1); and
a processing means (110) configured to a generate a plurality of input data vectors each comprising a current level of filling of the tank and a future sea state estimated by the sea state estimation device (123), and to estimate a future sloshing response of the tank from the input data vectors generated in this way and from the database (150) obtained by the method according to claim 10.

22. The management system (100) for a ship (1) including at least one sealed and thermally insulating tank (2) for transporting liquefied gas, the system comprising:
at least one level of filling sensor (121) for measuring a current level of filling of the tank (2);
a state of movement estimation device able to estimate future sea states from meteorological information and from a course of the ship (1); and
a processing means (110) configured to a generate a plurality of input data vectors each comprising a current level of filling of the tank and a future state of movement of the ship estimated by the state of movement of the ship estimation device, and to estimate a future sloshing response of the tank from the input data vectors generated in this way and from the database (150) obtained by the method according to claim 11.

23. The system according to claim 21, in which the processing means (110) is further configured to determine a course of the ship enabling reduction of the future sloshing response of the tank.
